(19) United States
(12) Patent Application Publication
(10) Pub. No.: US 2026/0074196 A1
(43) Pub. Date: Mar. 12, 2026

(54) COMPOSITE ANODE ACTIVE MATERIAL FOR ALL-SOLID-STATE-BATTERY AND MANUFACTURING METHOD THEREOF

(71) Applicants: Hyundai Motor Company, Seoul (KR); Kia Corporation, Seoul (KR)

(72) Inventors: So Yeon Kim, Suwon-si (KR); Hong Suk Choi, Hwaseong-si (KR); Seon Hwa Kim, Cheongju-si (KR); Dong Hyun Cho, Hwaseong-si (KR); Jae Seok Nam, Suwon-si (KR); Jae Min Lim, Suwon-si (KR); Hee Soo Kang, Seoul (KR)

(21) Appl. No.: 18/805,828

(22) Filed: Aug. 15, 2024

(30) Foreign Application Priority Data
Dec. 11, 2023 (KR) 10-2023-0178252

(51) Int. Cl. H01M 4/36; H01M 4/02; H01M 4/04; H01M 4/38; H01M 4/583

(52) U.S. Cl. CPC H01M 4/366; H01M 4/0404; H01M 4/0407; H01M 4/386; H01M 4/583; H01M 2004/021; H01M 2004/027; H01M 2300/0068

(57) ABSTRACT

An embodiment composite negative electrode active material for an all-solid-state battery includes a negative electrode active material including a silicon-based active material and a coating layer including a solid electrolyte and coating a portion of a surface of the negative electrode active material, wherein a ratio (E/T) of a Young's modulus (E) of the solid electrolyte to a thickness (T) of the coating layer satisfies 0.02<E/T<0.06.

### CROSS-REFERENCE TO RELATED APPLICATIONS

This application claims the benefit of Korean Patent Application No. 10-2023-0178252, filed on Dec. 11, 2023, which application is hereby incorporated herein by reference.

### TECHNICAL FIELD

The present disclosure relates to a composite anode active material for an all-solid-state battery and a manufacturing method thereof.

### BACKGROUND

Recently, to solve environmental problems caused by carbon dioxide (CO₂), the use of fossil fuels has been avoided. Accordingly, in industries where an automobile is used as a mode of transport, interest in electric vehicles (EVs) based on secondary batteries is growing. Although currently available lithium-ion batteries can travel about 400 km on a single charge, problems such as instability at high temperatures and fire remain unsolved. To solve these problems, many companies are competitively developing next-generation secondary batteries.

All-solid-state batteries, which are attracting attention as next-generation secondary batteries, are made of solid components and have the advantages of a lower risk of fire and explosion and higher mechanical strength than those of lithium-ion batteries based on flammable organic solvents as electrolytes. Typically, an all-solid-state battery includes a positive electrode active material layer bonded to a positive electrode current collector, a negative electrode active material layer bonded to a negative electrode current collector, and a solid electrolyte layer positioned between the positive and negative electrode active material layers.

A negative electrode active material layer is commonly used in a composite form of a negative electrode active material and a solid electrolyte to obtain lithium-ion conductivity in the negative electrode active material layer. Depending on the degree and method of forming the composite of the negative electrode active material and the solid electrolyte, differences in lithium-ion conductivity occur, leading to differences in the output characteristics and durability properties of the battery.

On the other hand, while a variety of negative electrode active materials are applicable to all-solid-state batteries compared to lithium-ion batteries, research has been recently conducted actively on applying materials having high energy density, such as silicon (up to 3600 mAh/g) or lithium (up to 3860 mAh/g), instead of existing graphite (up to 375 mAh/g).

Of all these materials, silicon exhibits a volume change of nearly 400% during the charging and discharging process. Thus, as the charging and discharging cycles increase, rapid capacity fade occurs due to the loss of contacting surface between silicon and the solid electrolyte present in a composite form in a negative electrode active material layer, making it challenging to use silicon-based active materials alone.

### SUMMARY

The present disclosure relates to a composite anode active material for an all-solid-state battery and a manufacturing method thereof. In particular embodiments, a ratio of the Young's modulus of a solid electrolyte contained in the composite negative electrode (anode) active material having a core-shell structure to the thickness of a coating layer, or a ratio of the thickness of the coating layer to the particle diameter of the negative electrode active material is adjusted to fall within a predetermined range, thereby minimizing the occurrence of interfacial cracks caused by expansion and contraction behavior of a negative electrode when charging and discharging the battery and improving the durability properties and output characteristics of the battery.

Embodiments of the present disclosure, which can solve problems in the art, aims to improve the output characteristics and durability properties of a battery by coating the surface of a silicon-based negative electrode active material with a solid electrolyte having high lithium-ion conductivity.

In this case, a change in volume of the silicon-based negative electrode active material is significant when charging and discharging the battery. Thus, when being repeatedly charged and discharged, cracks or pores may be formed on the interface between the solid electrolyte coating the surface of the silicon-based negative electrode active material and the solid electrolyte in the negative electrode active material layer, leading to an increase in interfacial resistance and a decrease in capacity development rate. Additionally, lithium may be irreversibly precipitated between the pores, leading to a decrease in discharge capacity.

Embodiments of the present disclosure aim to prevent the interfacial resistance from being increased and alleviate the impact of the volume change occurring when charging and discharging the battery by adjusting a ratio of the Young's modulus of the solid electrolyte coating the surface of the negative electrode active material to the thickness of a coating layer containing the solid electrolyte to fall within a predetermined range.

Additionally, embodiments of the present disclosure aim to prevent the interfacial resistance from being increased while improving coating uniformity by adjusting a ratio of the thickness of the coating layer, containing the solid electrolyte coating the surface of the negative electrode active material, to the particle diameter of the negative electrode active material to fall within a predetermined range.

Embodiments of the present disclosure are not limited to the embodiments mentioned above. The above and other embodiments of the present disclosure will become more apparent from the following description and will be realized by the means of the appended claims and combinations thereof.

According to one embodiment of the present disclosure, a composite negative electrode active material for an all-solid-state battery is provided, the composite negative electrode active material including a negative electrode active material containing a silicon-based active material and a coating layer containing a solid electrolyte coating at least a portion of a surface of the negative electrode active material, in which a ratio (E/T; GPa/nm) of a Young's modulus (E; GPa) of the solid electrolyte to a thickness (T; nm) of the coating layer satisfies 0.02<E/T<0.06.

In an embodiment, a ratio (T/d; nm/μm) of the thickness (T; nm) of the coating layer to a particle diameter (d; μm) of the negative electrode active material may satisfy 20<T/d<100.

In this case, the coating layer may have the thickness (T) in a range of 200 nm to 750 nm.

In an embodiment, the solid electrolyte may have the Young's modulus (E) in a range of 8 GPa to 22 GPa.

In an embodiment, the solid electrolyte may coat an entire surface of the negative electrode active material.

In an embodiment, the solid electrolyte may include a sulfide-based solid electrolyte.

In an embodiment, the silicon-based active material may include at least one material selected from the group consisting of a silicon particle, silicon oxide, a silicon alloy, and combinations thereof.

In the embodiment, the silicon-based active material may be a composite further containing a carbon-based material.

Another embodiment of the present disclosure provides a negative electrode active material layer for an all-solid-state battery, the negative electrode active material layer including the composite negative electrode active material and an electrode solid electrolyte.

A further embodiment of the present disclosure provides a method of forming a composite negative electrode active material layer, the method including synthesizing a composite negative electrode active material by introducing a negative electrode active material and a solid electrolyte into a mixer and then mixing the negative electrode active material and solid electrolyte, preparing a negative electrode active material slurry by mixing the composite negative electrode active material and an electrode solid electrolyte, and forming a negative electrode active material layer by applying and drying the negative electrode active material slurry on a negative electrode current collector, in which the negative electrode active material and the solid electrolyte are introduced into the mixer at a weight ratio in a range of 9:1 to 7:3.

In an embodiment, the mixer may include a resonant acoustic mixer (RAM).

In an embodiment, the mixer may include a plurality of metal balls having a diameter of 10 mm or less, and a weight ratio of the sum of the negative electrode active material and solid electrolyte in powder form to the metal balls may be in a range of 1:7 to 1:9

A composite negative electrode active material of embodiments of the present disclosure can prevent the interfacial resistance between electrolytes from being increased due to a change in volume of a silicon-based negative electrode active material by adjusting a ratio (E/T) of the Young's modulus (E) of a solid electrolyte to the thickness (T) of a coating layer to fall within 0.02<E/T<0.06.

Additionally, the interfacial resistance can be prevented from being increased while improving coating uniformity by adjusting a ratio (T/d) of the thickness (T) of the coating layer containing the solid electrolyte coating the surface of the negative electrode active material to the particle diameter (d) of the negative electrode active material to satisfy 20<T/d<100.

On the other hand, according to a method of forming a negative electrode active material layer of embodiments of the present disclosure, the negative electrode active material and the solid electrolyte are introduced into a mixer at a weight ratio in a range of 9:1 to 7:3 using a resonance acoustic mixer to prepare the composite negative electrode active material. Accordingly, side reactions between the negative electrode active material and the solid electrolyte can be more easily prevented from occurring.

Effects of embodiments of the present disclosure are not limited to the effects mentioned above. It should be understood that the effects of embodiments of the present disclosure include all the effects which can be deduced from the following description.

### BRIEF DESCRIPTION OF THE DRAWINGS

FIG. 1 shows a negative electrode active material layer according to embodiments of the present disclosure;

FIG. 2 shows a composite negative electrode active material and an electrode solid electrolyte surrounding the same, according to embodiments of the present disclosure;

FIG. 3 shows a composite negative electrode active material according to Preparation Example 1, the image taken with a scanning electron microscope (SEM);

FIG. 4 shows an analysis result for a sulfur(S) element contained in the composite negative electrode active material according to FIG. 3, the analysis performed with energy-dispersive X-ray spectroscopy (EDS);

FIG. 5 shows an EDS analysis result for a silicon (Si) element contained in the composite negative electrode active material according to FIG. 3; and

FIG. 6 shows durability evaluation results by charging and discharging compression cells according to examples and comparative examples.

### DETAILED DESCRIPTION OF ILLUSTRATIVE EMBODIMENTS

The above objectives, and other objectives, features, and advantages of embodiments of the present disclosure will be readily understood from the following preferred embodiments associated with the accompanying drawings. However, the present disclosure is not limited to the embodiments described herein and may be embodied in other forms. The embodiments described herein are provided so that the disclosure can be made thorough and complete and the spirit of the present disclosure can be fully conveyed to those skilled in the art. Throughout the drawings, like elements are denoted by like reference numerals. In the accompanying drawings, the dimensions of the structures are larger than actual sizes for clarity of the present disclosure. Terms used herein, such as “first”, “second”, etc., may be used to describe various components, but the components are not to be construed as being limited to the terms. These terms are used only for the purpose of distinguishing a component from another component. For example, without departing from the scope of the present disclosure, a first component may be referred to as a second component, and a second component may be also referred to as a first component. As used herein, the singular forms “a”, “an”, and “the” are intended to include the plural forms as well unless the context clearly indicates otherwise. It will be further understood that the terms “comprises”, “includes”, or “has” when used herein specify the presence of stated features, regions, integers, steps, operations, elements, and/or components, but do not preclude the presence or addition of one or more other features, regions, integers, steps, operations, elements, components, and/or combinations thereof. It will also be understood that when an element such as a layer, film, area, or sheet is referred to as being “on” another element, it can be directly on the other element or intervening elements may be present therebetween. Similarly, when an element such as a layer, film, area, or sheet is referred to as being “under” another element, it can be directly under the other element or intervening elements may be present therebetween. Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous and includes all values from the minimum value of said range to the maximum value thereof, unless otherwise indicated. Moreover, when such a range pertains to integer values, all integers including the minimum value to the maximum value are included, unless otherwise indicated. In this specification, when a range is described for a variable, the variable will be understood to include all values within the stated range, including the stated endpoints of the range. For example, a range of “5 to 10” includes values of 5, 6, 7, 8, 9, and 10, as well as any subranges such as 6 to 10, 7 to 10, 6 to 9, and 7 to 9. It will be understood to include any value between reasonable integers within the scope of the stated range, such as 5.5, 6.5, 7.5, 5.5 to 8.5, and 6.5 to 9. Additionally, for example, a range of “10% to 30%” includes values, such as 10%, 11%, 12%, and 13%, and all integers up to and including 30%, as well as any subranges such as 10% to 15%, 12% to 18%, and 20% to 30%. It will be understood to include any value between reasonable integers within the scope of the stated range, such as 10.5%, 15.5%, and 25.5%.

Composite Negative Electrode Active Material for an all-Solid-State Battery

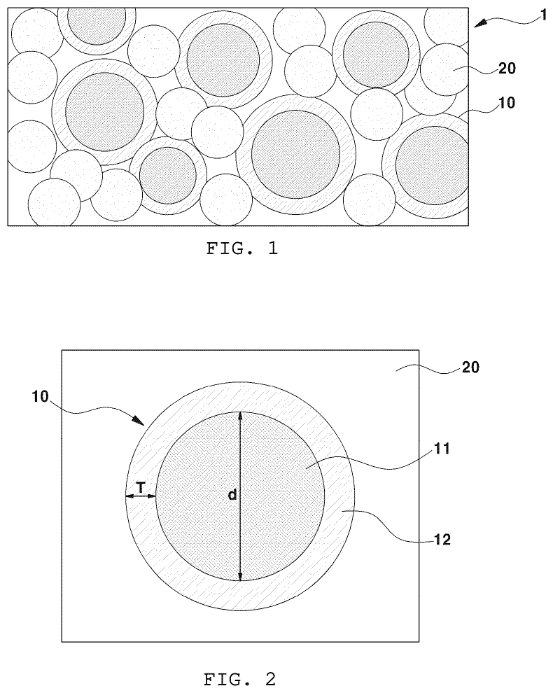

FIG. 1 shows composite negative electrode active materials 10 and a negative electrode active material layer 1 including the same, according to embodiments of the present disclosure. Referring to FIG. 1, the negative electrode active material layer 1, according to embodiments of the present disclosure, may include the composite negative electrode active materials 10 and electrode solid electrolytes 20 filling gaps between the composite negative electrode active materials 10.

When charging a typical all-solid-state battery, lithium ions are released from a positive electrode active material layer and move to a negative electrode active material layer through a solid electrolyte layer. The lithium ions that have moved to the negative electrode active material layer may be stored in or on the surface of the negative electrode active material. In this case, when the negative electrode active material layer contains the electrode solid electrolyte 20 having high lithium-ion conductivity as in embodiments of the present disclosure, the movement and storage of such lithium ions in the negative electrode active material layer may easily occur.

The electrode solid electrolyte 20 may be contained in the negative electrode active material layer 1 and may include a solid electrolyte having high lithium-ion conductivity.

The electrode solid electrolyte 20 may include an oxide-based solid electrolyte, a sulfide-based solid electrolyte, and the like. In one example, a sulfide-based solid electrolyte having high lithium-ion conductivity is preferably used as the electrode solid electrolyte 20. The sulfide-based solid electrolyte is not particularly limited, but examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each independently a positive integer, and Z is one among Ge, Zn, and Ga), Li₂S—GeS₂, Li₂S—SiS₂—Li₃PO₄, Li₂S—SiS₂-LiₓMO_{y} (where x and y are each independently a positive integer, and M is one among P, Si, Ge, B, Al, Ga, and In), Li₁₀GeP₂S₁₂, and the like.

Examples of the oxide-based solid electrolyte may include a perovskite-type LLTO (Li₃ₓLa_{2/3-x}TiO₃), a phosphate-based NASICON-type LATP (Li₁₊ₓAlₓTi₂₋ₓ(PO₄)₃), and the like.

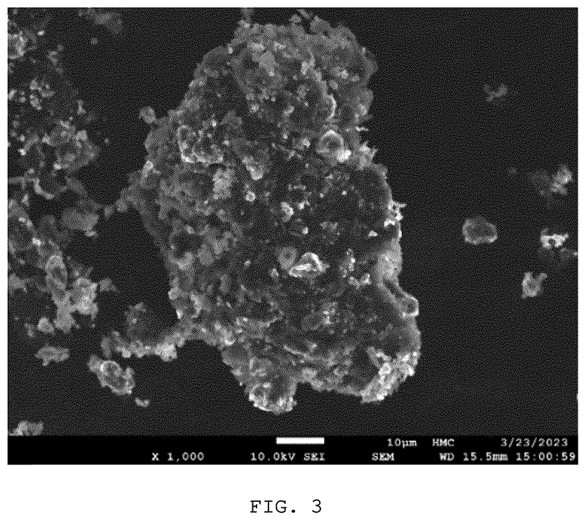

FIG. 2 shows the composite negative electrode active material 10 and the electrode solid electrolyte 20 surrounding the same, according to embodiments of the present disclosure. In this case, the electrode solid electrolyte 20 illustrated in FIG. 2 is appropriately simplified. The composite negative electrode active material 10 may include a negative electrode active material 11 containing a silicon-based active material and a coating layer 12 containing a solid electrolyte coating at least a portion of a surface of the negative electrode active material 11. In other words, the composite negative electrode active material 10 may have a core-shell structure in which the silicon-based active material serves as a core, and the solid electrolyte serves as a shell. Preferably, the solid electrolyte may coat an entire surface of the negative electrode active material 11.

The silicon-based active material has a higher theoretical capacity than existing graphite-based negative electrode active materials 11, and any active material containing silicon may be used without particular limitation. For example, the silicon-based active material may include at least one material selected from the group consisting of a silicon particle, silicon oxide, a silicon alloy, and combinations thereof.

Additionally, the silicon-based active material may be a composite containing a carbon-based material. For example, the silicon-based active material may be a composite formed by coating at least a portion of a surface of the silicon particle, silicon oxide, or silicon alloy with the carbon-based material. Alternatively, at least a portion of a surface of the carbon-based material may be coated with the silicon particle, silicon oxide, or silicon alloy to form a composite. Additionally, the silicon-based active material may be a composite containing the silicon particle, silicon oxide, or silicon alloy and the carbon-based material as primary particles, where the primary particles aggregate to form secondary particles.

The composite negative electrode active material 10 may obtain high theoretical capacity by using the silicon-based active material as the core. Additionally, at least a portion of a surface of the negative electrode active material 11, containing the silicon-based active material, may be coated with the solid electrolyte having high lithium-ion conductivity, thus facilitating the storage and release of lithium ions when charging and discharging the battery.

On the other hand, a solid-state electrolyte having high lithium-ion conductivity may be used as the solid electrolyte contained in the coating layer 12, the electrolyte coating at least a portion of a surface of the negative electrode active material 11.

The solid electrolyte may include an oxide-based solid electrolyte, a sulfide-based solid electrolyte, and the like. In one example, a sulfide-based solid electrolyte having high lithium-ion conductivity is preferably used as the solid electrolyte. The sulfide-based solid electrolyte is not particularly limited, but examples thereof may include Li₂S—P₂S₅, Li₂S—P₂S₅—LiI, Li₂S—P₂S₅—LiCl, Li₂S—P₂S₃—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each independently a positive integer, and Z is one among Ge, Zn, and Ga), Li₂S—GeS₂, Li₂S—SiS₂—Li₃PO₄, Li₂S—SiS₂-LiₓMO_{y} (where x and y are each independently a positive integer, and M is one among P, Si, Ge, B, Al, Ga, and In), Li₁₀GeP₂S₁₂, and the like.

On the other hand, the solid electrolyte contained in the coating layer 12 and the electrode solid electrolyte 20 contained in the negative electrode active material layer 1 may be the same or different from each other.

In one example, in the composite negative electrode active material 10 according to embodiments of the present disclosure, a ratio (E/T; GPa/nm) of the Young's modulus (E; GPa) of the solid electrolyte to the thickness (T; nm) of the coating layer 12 may satisfy 0.02<E/T<0.06.

Young's modulus (E) is a coefficient indicating how the relative length of an elastic object changes in response to stress, meaning that the lower the Young's modulus, the lower the stiffness, and the higher the Young's modulus, the higher the stiffness.

Although Young's modulus is a generalized coefficient in Hooke's law for elastic objects, this value is irrelevant to the form in which the object is processed and may only be affected by the unique mechanical properties of the material constituting the object. Therefore, when measuring the Young's modulus of the electrode solid electrolyte 20, the value thereof is unnecessary to be measured after preparing the electrode solid electrolyte 20 in a form contained in the composite negative electrode active material 10 or the negative electrode active material layer 1. Additionally, the measurement may be performed after processing the electrode solid electrolyte 20 in the form of a sample where the Young's modulus is allowed to be easily measured.

When the ratio (E/T; GPa/nm) of the Young's modulus (E; GPa) of the solid electrolyte to the thickness (T; nm) of the coating layer 12 satisfies 0.02<E/T<0.06, the coating layer 12 containing the solid electrolyte may obtain sufficient coating properties and stiffness. Accordingly, the contraction and expansion of the negative electrode active material 11, occurring when charging and discharging the battery, are appropriately prevented and accommodated. Additionally, the interfacial contact between the electrode solid electrolyte 20 and the composite negative electrode active material 10 is maintained at a high level to prevent cracks from occurring and the interfacial resistance from being increased. Additionally, irreversible lithium precipitation caused by the occurrence of cracks may be prevented.

On the other hand, the Young's modulus (E) of the solid electrolyte and the thickness (T) of the coating layer 12 may be inversely proportional. Typically, the lower the Young's modulus, the better the coating properties, leading to an increase in the thickness (T) of the coating layer 12.

When the ratio (E/T) of the Young's modulus (E) of the solid electrolyte to the thickness (T) of the coating layer 12 is 0.02 GPa/nm or lower, the Young's modulus of the solid electrolyte may be relatively low, and the thickness (T) of the coating layer 12 may be relatively large. When the Young's modulus of the solid electrolyte is low, the coating properties of the solid electrolyte are satisfactory. However, interfacial contact properties after the expansion and/or contraction of the negative electrode active material 11 may be poor due to a lack of mechanical properties. Additionally, the larger the thickness (T) of the coating layer 12, the higher the interfacial resistance and the resistance of the coating layer 12 itself, leading to a deterioration in cell performance.

When the ratio (E/T) of the Young's modulus (E) of the solid electrolyte to the thickness (T) of the coating layer 12 is 0.06 GPa/nm or higher, the Young's modulus of the solid electrolyte may be relatively high, and the thickness (T) of the coating layer 12 may be relatively small. When the Young's modulus of the solid electrolyte is high, the coating properties of the solid electrolyte may be poor, and restoring force may be insufficient when the negative electrode active material 11 expands and/or contracts. Accordingly, the coating layer 12 may be prone to fracture during durability evaluation. Additionally, as the thickness (T) of the coating layer 12 is reduced, the capability to prevent expansion and/or contraction of the negative electrode active material 11 from occurring may be poor due to a lack of mechanical properties.

In one example, a ratio (T/d; nm/μm) of the thickness (T; nm) of the coating layer 12 to the particle diameter (d; μm) of the negative electrode active material 11 may satisfy 20<T/d<100. When the ratio (T/d; nm/μm) of the thickness (T) of the coating layer 12 to the particle diameter (d) of the negative electrode active material 11 satisfies 20<T/d<100, the coating uniformity of the solid electrolyte may be improved. Additionally, the interfacial resistance between the composite negative electrode active material 10 and the electrode solid electrolyte 20 may be reduced while obtaining sufficient mechanical properties. Accordingly, the output and durability performance of the all-solid-state battery, containing the composite negative electrode active material 10, may be improved.

In this case, the particle diameter (d) of the negative electrode active material 11 refers to a mean particle diameter (D₅₀), which may include a particle diameter measurable from the resulting cross-sectional image of the composite negative electrode active material 10 and a particle diameter of a raw material of the negative electrode active material 11 used in the process of preparing the composite negative electrode active material 10. The mean particle diameter may be calculated through measurement performed with, for example, a laser diffraction-type particle size distribution meter or a scanning electron microscope (SEM). Additionally, the thickness (T) of the coating layer 12 may include a thickness measurable from the resulting cross-sectional image of the composite negative electrode active material 10 and a thickness calculated using the mass, particle diameter, density, surface area per particle, and the like of the solid electrolyte and the negative electrode active material 11.

On the other hand, the mean particle diameter of the negative electrode active material 11 and the thickness (T) of the coating layer 12 may be measured through the following process.

A sample is prepared by embedding the composite negative electrode active material 10 in a resin material. The sample may be cut or crushed using a known ion milling machine and processed to observe a cross section. For example, “ArBlade (registered trademark) 5000” (or equivalents thereof), an ion milling system purchased from Hitachi High-Tech, may be used. Next, the cross section of the sample is observed using a scanning electron microscope (SEM). For example, “product name SU8030” (or equivalents thereof), an SEM purchased from Hitachi High-Tech, may be used. Regarding each of the 10 particles of the composite negative electrode active material 10, the particle diameter (d) of the negative electrode active material 11 and the thickness (T) of the coating layer 12 each may be independently measured from 20 different views. After measuring the particle diameter (d) of a total of 200 particles of the negative electrode active material 11 and the thickness (T) of the coating layer 12, the arithmetic mean values thereof each may be independently calculated to be regarded as the particle diameter (d) of the negative electrode active material 11 and the thickness (T) of the coating layer 12.

When the ratio (T/d; nm/μm) of the thickness (T) of the coating layer 12 to the particle diameter (d) of the negative electrode active material 11 does not fall within the above numerical range, the thickness (T) of the coating layer 12 may be excessively increased compared to the particle diameter (d) of the negative electrode active material 11. Thus, the coating uniformity may be poor, and the interfacial resistance and the resistance of the coating layer 12 itself may increase. Accordingly, the output and durability of the battery may be deteriorated.

On the other hand, it is preferable that the composite negative electrode active material 10, according to embodiments of the present disclosure, satisfies both the ratio (E/T; GPa/nm) of the Young's modulus (E) of the solid electrolyte to the thickness (T) of the coating layer 12 of 0.02<E/T<0.06 and the ratio (T/d) of the thickness (T) of the coating layer 12 to the particle diameter (d) of the negative electrode active material 11 of 20<T/d<100. When the composite negative electrode active material 10 satisfies both of the above two numerical ranges regarding the E/T and T/d ratios, contraction and expansion of the negative electrode active material 11, as well as cracks occurring between the negative electrode active material 11 and the coating layer 12, may be prevented, not to mention that interfacial contact properties between the composite negative electrode active material 10 and the electrode solid electrolyte 20 may be prevented from being deteriorated.

On the other hand, the thickness (T) of the coating layer 12 is preferably in a range of 200 nm to 750 nm. When the thickness (T) of the coating layer 12 exceeds 750 nm, the interfacial resistance between the composite negative electrode active material 10 and the electrode solid electrolyte 20 and the resistance of the coating layer 12 itself may increase, leading to a deterioration in cell performance. On the contrary, when the thickness (T) of the coating layer 12 is smaller than 200 nm, the capability to prevent expansion and/or contraction of the negative electrode active material 11 may be poor due to a lack of mechanical properties.

In one example, the solid electrolyte may have a Young's modulus (E) in a range of 8 GPa to 22 GPa. When the Young's modulus of the solid electrolyte exceeds 22 GPa, the coating properties of the solid electrolyte may be poor, and restoring force may be insufficient when the negative electrode active material 11 expands and/or contracts. On the contrary, when the Young's modulus of the solid electrolyte is lower than 8 GPa, interfacial contact properties after the expansion and/or contraction of the negative electrode active material 11 may be poor due to a lack of mechanical properties.

Method of Forming Negative Electrode Active Material Layer for an all-Solid-State Battery

A method of forming a composite negative electrode active material layer 1 for an all-solid-state battery, according to embodiments of the present disclosure, may include synthesizing a composite negative electrode active material 10 by introducing a negative electrode active material 11 and a solid electrolyte into a mixer and then mixing the negative electrode active material 11 and the solid electrolyte, preparing a negative electrode active material slurry by mixing the composite negative electrode active material 10 and an electrode solid electrolyte 20, and forming a negative electrode active material layer 1 by applying and drying the negative electrode active material slurry on a negative electrode current collector.

In this case, the negative electrode active material 11 is practically the same as the one described above and may contain a silicon-based active material. Alternatively, the negative electrode active material 11 further containing a carbon-based material may be used.

Typically, a method of preparing the composite negative electrode active material 10 having a core-shell structure by coating at least a portion of the surface of the silicon-based negative electrode active material with the solid electrolyte may be divided into a wet method of dissolving the solid electrolyte in a solvent to prepare a solution and coating the negative electrode active material 11 with the prepared solution and a dry method of crushing the negative electrode active material 11 and a solid electrolyte raw material crushed using a paint shaker or Thinkey mixer and coating the negative electrode active material 11 with the crushed materials.

In the method of forming the negative electrode active material layer 1 according to embodiments of the present disclosure, the composite negative electrode active material 10 may be prepared by introducing the negative electrode active material 11 and the solid electrolyte into a resonant acoustic mixer (RAM) and mixing the introduced negative electrode active material 11 and the solid electrolyte.

The resonance acoustic mixer is a device that disperses, crushes, or coats particles of a mixture by efficiently transferring energy to the mixture using resonance. Specifically, the mixture may be induced to an acoustic resonance state using a resonant acoustic frequency capable of refining the size of the particles constituting the mixture. In this case, acoustic energy including the resonant acoustic frequency may be accumulated inside the particles constituting the mixture and allow the particles to be distinctively dispersed inside the structure or into the surrounding medium.

In the method of forming the negative electrode active material layer 1 according to embodiments of the present disclosure, the resonant acoustic mixer whose energy transfer efficiency is higher than that of an existing paint shaker or Thinky mixer may be used. Accordingly, the mixing may be performed for 2 minutes to 15 minutes using the resonant acoustic mixer, which may be much less time-consuming than existing wet and dry methods.

According to the method of forming the negative electrode active material layer 1 of embodiments of the present disclosure, the composite negative electrode active material 10 may be prepared at a lower temperature using the resonance acoustic mixer than in other preparation methods. Thus, side reactions between the solid electrolyte and the carbon contained in the silicon-based negative electrode active material 11 may be prevented from occurring. Additionally, the mixing may be much less time-consuming than other formation methods, thus improving process efficiency.

In one example, the negative electrode active material 11 and the solid electrolyte may be introduced into the mixer at a weight ratio in a range of 9:1 to 7:3. The thickness (T) of the coating layer 12, according to embodiments of the present disclosure, may be affected by the weight ratio between the negative electrode active material 11 and the solid electrolyte introduced into the mixer. For example, when introducing a relatively large amount of the solid electrolyte while falling within the above numerical range, the thickness (T) of the coating layer 12 may be increased. On the contrary, when introducing a relatively small amount of the solid electrolyte while falling within the above numerical range, the thickness (T) of the coating layer 12 may be reduced.

Additionally, when introducing a larger amount of the negative electrode active material 11 while not falling within the above numerical range, the thickness (T) of the coating layer 12 of the composite negative electrode active material 10 may be reduced, and the lithium-ion conductivity may be poor. Additionally, when introducing a larger amount of the solid electrolyte while not falling within the above numerical range, the relative amount of the negative electrode active material 11 may be small, leading to a decrease in energy density of the battery. Furthermore, the larger the thickness (T) of the coating layer 12, the higher the interfacial resistance and the resistance of the coating layer 12 itself, leading to a deterioration in cell performance.

In one example, the composite negative electrode active material 10, prepared according to the above preparation method, may satisfy a ratio (E/T; GPa/nm) of the Young's modulus (E; GPa) of the solid electrolyte to the thickness (T; nm) of the coating layer 12 of 0.02<E/T<0.06. Additionally, the composite negative electrode active material 10, prepared according to the above preparation method, may satisfy a ratio (E/T; GPa/nm) of the Young's modulus (E; GPa) of the solid electrolyte to the thickness (T; nm) of the coating layer 12 of 0.02<E/T<0.06.

On the other hand, a plurality of metal balls having a diameter of 10 mm or less, for example, zirconia balls (ZrO₂), may be introduced into the resonance acoustic mixer in combination with the negative electrode active material 11 and the solid electrolyte. Preferably, zirconia balls having a diameter of 5 mm are introduced. In this case, the negative electrode active material 11 and the solid electrolyte that are powdered and the metal balls may be present in a weight ratio in a range of 1:7 to 1:9. Additionally, coating efficiency may be improved by introducing the metal balls into the resonance acoustic mixer in a predetermined range.

The composite negative electrode active material 10 may be synthesized through the above process and then introduced into a solvent in combination with the electrode solid electrolyte 20 to prepare the negative electrode active material slurry. Next, the negative electrode active material slurry may be applied and dried on the negative electrode current collector to form the negative electrode active material layer 1 for the all-solid-state battery.

In this case, the solvent commonly used in the process of preparing negative electrode active material slurries, such as N-methyl-2 pyrrolidone (NMP), may be used.

The negative electrode current collector, configured to transmit current to the negative electrode active material 11 or receive current from the negative electrode active material 11 during charging and discharging of the battery, may be an electrically conductive substrate having a plate-like form. Specifically, the negative electrode current collector may have a form of a sheet, a thin film, or foil.

The negative electrode current collector may contain a material that does not react with lithium. Specifically, the negative electrode current collector may include at least one material selected from the group consisting of nickel (Ni), copper (Cu), stainless steel, and combinations thereof. The thickness of the negative electrode current collector is not particularly limited but may be, for example, in a range of 1 μm to 500 μm.

Since the description of each configuration of the negative electrode active material layer 1 formed according to the method of forming the negative electrode active material layer 1 for the all-solid-state battery is practically the same as that described for the composite negative electrode active material 10, a detailed description will be omitted.

Hereinafter, embodiments of the present disclosure will be described in detail with reference to the following examples and comparative examples. However, the spirit of the present disclosure is not limited thereto.

### Preparation Example 1

(a) A Si/C composite having a particle diameter of about 6 μm was prepared as a negative electrode active material, and a sulfide-based solid electrolyte having a Young's modulus (E) of 8.3 GPa was prepared as a solid electrolyte to be contained in a coating layer.
(b) Such prepared negative electrode active material and the solid electrolyte that were powdered were weighed at a weight ratio of 9:1 and then introduced into a resonance acoustic mixer (RESODYN, LabRAM1 model). Additionally, zirconia balls were introduced into the resonance acoustic mixer such that a weight ratio of the negative electrode active material and the solid electrolyte that were powdered to the zirconia balls (ZrO₂) was set to 1:8.

Next, mixing was performed for 10 minutes under a condition of about 80 G to obtain a composite negative electrode active material having a core-shell structure having a form in which a silicon-based active material served as a core and at least a portion of the surface of the silicon-based active material was coated with the solid electrolyte.
(c) The composite negative electrode active material and an argyrodite-type sulfide-based solid electrolyte, prepared as an electrode solid electrolyte, were introduced into NMP, an organic solvent, and then mixed to prepare a negative electrode active material slurry. Next, the negative electrode active material slurry was applied and dried on a nickel (Ni) foil, a negative electrode current collector to form a negative electrode active material layer, thereby obtaining a negative electrode having a form in which the negative electrode active material layer was stacked on the negative electrode current collector.

### Preparation Example 2

A negative electrode was obtained through the same process as in Preparation Example 1, except that a sulfide-based solid electrolyte having a Young's modulus (E) of 16.5 GPa was used as the solid electrolyte to be contained in the coating layer, and such prepared negative electrode active material and solid electrolyte that were powdered were weighed at a weight ratio of 8:2 and then introduced into the resonance acoustic mixer.

### Preparation Example 3

A negative electrode was obtained through the same process as in Preparation Example 1, except that a Si/C composite having a particle diameter of about 15 μm was prepared as the negative electrode active material, a sulfide-based solid electrolyte having a Young's modulus (E) of 21.8 GPa was used as the solid electrolyte to be contained in the coating layer, and such prepared negative electrode active material and solid electrolyte that were powdered were weighed at a weight ratio of 7.5:2.5 and then introduced into the resonance acoustic mixer.

### Preparation Example 4

A negative electrode was obtained through the same process as in Preparation Example 2, except that a Si/C composite having a particle diameter of about 8 μm was prepared as the negative electrode active material.

### Comparative Preparation Example 1

A negative electrode was obtained through the same process as in Preparation Example 1, except that the coating layer containing the solid electrolyte was not formed on the surface of the negative electrode active material.

### Comparative Preparation Example 2

A negative electrode was obtained through the same process as in Preparation Example 1, except that the negative electrode active material and the solid electrolyte were introduced into the resonance acoustic mixer at a weight ratio of 7:3.

### Comparative Preparation Example 3

A negative electrode was obtained through the same process as in Preparation Example 2, except that the negative electrode active material and the solid electrolyte were introduced into the resonance acoustic mixer at a weight ratio of 9:1.

### Comparative Preparation Example 4

A negative electrode was obtained through the same process as in Preparation Example 2, except that the negative electrode active material and the solid electrolyte were introduced into the resonance acoustic mixer at a weight ratio of 7:3.

### Comparative Preparation Example 5

A negative electrode was obtained through the same process as in Preparation Example 3, except that the negative electrode active material and the solid electrolyte were introduced into the resonance acoustic mixer at a weight ratio of 8.5:1.5.

### Comparative Preparation Example 6

A negative electrode was obtained through the same process as in Preparation Example 3, except that a sulfide-based solid electrolyte having a Young's modulus (E) of 26.9 GPa was used as the solid electrolyte to be contained in the coating layer.

### Comparative Preparation Example 7

A negative electrode was obtained through the same process as in Comparative Preparation Example 6, except that the negative electrode active material and the solid electrolyte were introduced into the resonance acoustic mixer at a weight ratio of 7:3.

Table 1 shows the conditions of the composite negative electrode active materials used in the process of obtaining the negative electrodes according to the preparation examples and the comparative preparation examples. In this case, the thickness (T) of the coating layer was measured using one of the methods of measuring the thickness of the coating layer described above.

TABLE 1

| | Negative | | | | | |
|---|---|---|---|---|---|---|
| | electrode | | | Ratio regarding coating specification | | |
| | active | | | Ratio of active | | |
| | material | Solid electrolyte | | material to | E/T | T/d |
| Classification | D (μm) | E (GPa) | T (nm) | electrolyte | (GPa/nm) | (nm/μm) |
| Preparation | 6 | 8.3 | 250 | 9:1 | 0.033 | 41.7 |
| Example 1 | | | | | | |
| Preparation | 6 | 16.5 | 400 | 8:2 | 0.041 | 66.7 |
| Example 2 | | | | | | |
| Preparation | 15 | 21.8 | 400 | 7.5:2.5 | 0.055 | 26.7 |
| Example 3 | | | | | | |
| Preparation | 8 | 16.5 | 400 | 8:2 | 0.041 | 50.0 |
| Example 4 | | | | | | |
| Comparative | 6 | not | not | not | — | — |
| Preparation | | coated | coated | coated | | |
| Example 1 | | | | | | |
| Comparative | 6 | 8.3 | 700 | 7:3 | 0.012 | 116.7 |
| Preparation | | | | | | |
| Example 2 | | | | | | |
| Comparative | 6 | 16.5 | 250 | 9:1 | 0.066 | 41.7 |
| Preparation | | | | | | |
| Example 3 | | | | | | |
| Comparative | 6 | 16.5 | 700 | 7:3 | 0.024 | 116.7 |
| Preparation | | | | | | |
| Example 4 | | | | | | |
| Comparative | 15 | 21.8 | 250 | 8.5:1.5 | 0.087 | 16.7 |
| Preparation | | | | | | |
| Example 5 | | | | | | |
| Comparative | 6 | 26.9 | 250 | 9:1 | 0.108 | 41.7 |
| Preparation | | | | | | |
| Example 6 | | | | | | |
| Comparative | 6 | 26.9 | 700 | 7:3 | 0.038 | 116.7 |
| Preparation | | | | | | |
| Example 7 | | | | | | |

### Experimental Example 1—SEM and EDS Analysis of a Composite Negative Electrode Active Material

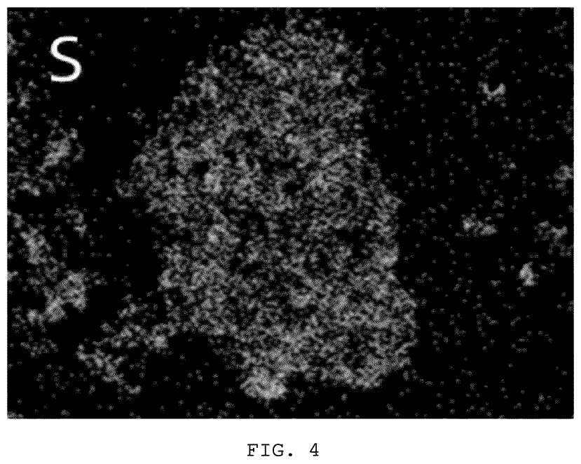

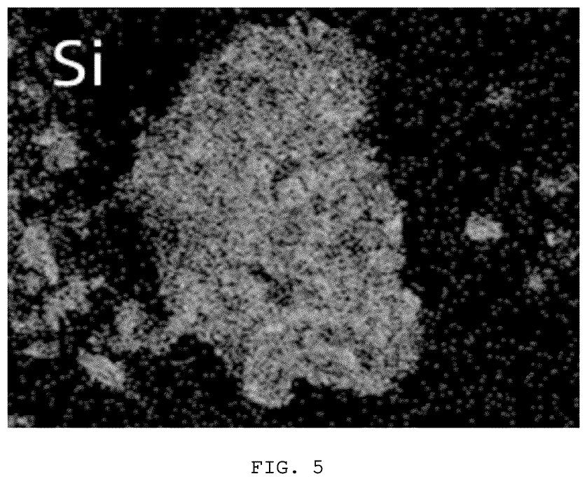

In the process of manufacturing the negative electrode according to Preparation Example 1, an image of the composite negative electrode active material synthesized through (b) was taken with a scanning electron microscope (SEM). The result thereof is shown in FIG. 3. Additionally, the same composite negative electrode active material was mapped for sulfur(S) and silicon (Si) elements with energy-dispersive X-ray spectroscopy (EDS). The respective results thereof are shown in FIGS. 4 and 5.

Referring to FIGS. 4 and 5, both sulfur(S) and silicon (Si) were observed in the synthesized composite negative electrode active material, confirming that at least a portion of the surface of the silicon-based negative electrode active material was properly coated with the solid electrolyte.

### Example 1

(a) The negative electrode according to Preparation Example 1, Li₆PS₅Cl, a sulfide-based solid electrolyte having an argyrodite-type crystal structure, and a lithium (Li) foil were prepared.
(b) The negative electrode, a solid electrolyte layer containing Li₆PS₅Cl, the sulfide-based solid electrolyte having the argyrodite-type crystal structure, and the lithium (Li) foil were stacked in such an order and then compressed to manufacture a compression cell for an all-solid-state battery.

### Example 2

A compression cell was manufactured through the same process as in Example 1, except for using the negative electrode according to Preparation Example 2.

### Example 3

A compression cell was manufactured through the same process as in Example 1, except for using the negative electrode according to Preparation Example 3.

### Example 4

A compression cell was manufactured through the same process as in Example 1, except for using the negative electrode according to Preparation Example 4.

### Comparative Example 1

A compression cell was manufactured through the same process as in Example 1, except for using the negative electrode according to Comparative Preparation Example 1.

### Comparative Example 2

A compression cell was manufactured through the same process as in Example 1, except for using the negative electrode according to Comparative Preparation Example 2.

### Comparative Example 3

A compression cell was manufactured through the same process as in Example 1, except for using the negative electrode according to Comparative Preparation Example 3.

### Comparative Example 4

A compression cell was manufactured through the same process as in Example 1, except for using the negative electrode according to Comparative Preparation Example 4.

### Comparative Example 5

A compression cell was manufactured through the same process as in Example 1, except for using the negative electrode according to Comparative Preparation Example 5.

### Comparative Example 6

A compression cell was manufactured through the same process as in Example 1, except for using the negative electrode according to Comparative Preparation Example 6.

### Comparative Example 7

A compression cell was manufactured through the same process as in Example 1, except for using the negative electrode according to Comparative Preparation Example 7.

### Experimental Example 2—Output Evaluation and Durability Evaluation of a Compression Cell

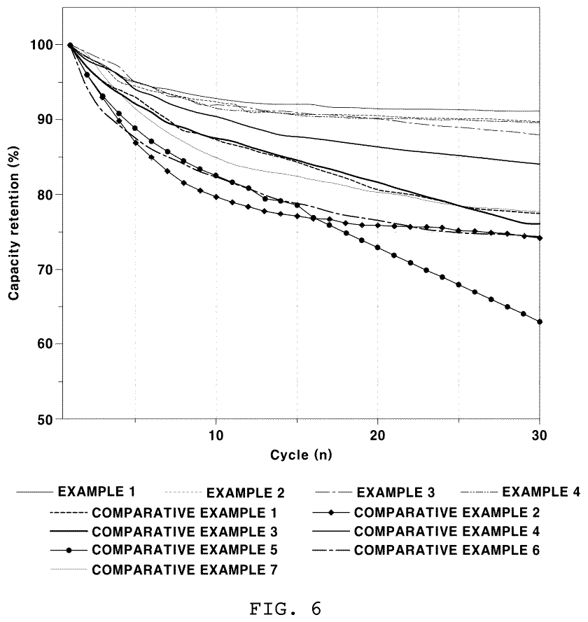

For the durability measurement of the compression cells manufactured according to the examples and the comparative examples, the compression cells, manufactured according to the examples and the comparative examples, were charged and discharged twice under the conditions shown in Table 2 to conduct output evaluation. Subsequently, 50 cycles of charging and discharging were performed under the conditions shown in Table 2 to conduct durability evaluation. The results thereof are shown in Table 2 and FIG. 6.

TABLE 2

| | | | Durability |
|---|---|---|---|
| | Output evaluation | | evaluation |
| | Discharge | Discharge capacity | 0.2 C |
| | capacity at 0.1 C | at 0.33 C | (30^{th}/4^{th}) |
| Category | (mAh/g) | (mAh/g) | (%) |
| Example 1 | 190.3 | 175.0 | 91.1 |
| Example 2 | 191.2 | 174.3 | 89.7 |
| Example 3 | 184.7 | 165.1 | 88.0 |
| Example 4 | 185.1 | 166.7 | 89.6 |
| Comparative | 165 | 144.8 | 77.4 |
| Example 1 | | | |
| Comparative | 167.5 | 143.3 | 74.3 |
| Example 2 | | | |
| Comparative | 175.3 | 152.9 | 76.0 |
| Example 3 | | | |
| Comparative | 181.4 | 161.7 | 84.1 |
| Example 4 | | | |
| Comparative | 165.5 | 144.9 | 63.0 |
| Example 5 | | | |
| Comparative | 171.1 | 153.0 | 74.4 |
| Example 6 | | | |
| Comparative | 180.7 | 161.2 | 77.7 |
| Example 7 | | | |

From Table 2, it is confirmed that in the case of Examples 1 to 4, where the ratio (E/T; GPa/nm) of the Young's modulus (E) of the solid electrolyte to the thickness (T) of the coating layer satisfies 0.02<E/T<0.06 while the ratio (T/d) of the thickness (T) of the coating layer to the particle diameter (d) of the negative electrode active material satisfies 20<T/d<100, the output characteristics and durability properties are excellent compared to those in the case of Comparative Examples 1 to 7, where either one or both of the ratios above fails to be satisfied.

Among the comparative examples, Comparative Examples 2 and 5, where neither the ratio (E/T; GPa/nm) of the Young's modulus (E) of the solid electrolyte to the thickness (T) of the coating layer of 0.02<E/T<0.06 nor the ratio (T/d) of the thickness (T) of the coating layer to the particle diameter (d) of the negative electrode active material of 20<T/d<100 was satisfied, the output characteristics and durability properties were particularly poor. Additionally, in the case of Comparative Example 1, where the coating layer was not formed, the output characteristics were measured to be the poorest among all examples and comparative examples.

Although preferred embodiments of the present disclosure have been disclosed for illustrative purposes, those skilled in the art will appreciate that diverse variations and modifications are possible through addition, alteration, deletion, etc. of elements, without departing from the spirit and scope of the present disclosure.

What is claimed is:

1. A composite negative electrode active material for an all-solid-state battery, the composite negative electrode active material comprising:
a negative electrode active material comprising a silicon-based active material; and
a coating layer comprising a solid electrolyte and coating at least a portion of a surface of the negative electrode active material, wherein a ratio (E/T) of a Young's modulus (E) of the solid electrolyte to a thickness (T) of the coating layer satisfies 0.02<E/T<0.06.

2. The composite negative electrode active material of claim 1, wherein a ratio (T/d) of the thickness (T) of the coating layer to a particle diameter (d) of the negative electrode active material satisfies 20<T/d<100.

3. The composite negative electrode active material of claim 2, wherein the thickness of the coating layer is in a range of 200 nm to 750 nm.

4. The composite negative electrode active material of claim 2, wherein the Young's modulus of the solid electrolyte is in a range of 8 GPa to 22 GPa.

5. The composite negative electrode active material of claim 2, wherein the solid electrolyte coats an entirety of the surface of the negative electrode active material.

6. The composite negative electrode active material of claim 2, wherein the solid electrolyte comprises a sulfide-based solid electrolyte.

7. The composite negative electrode active material of claim 2, wherein the silicon-based active material comprises a material selected from the group consisting of a silicon particle, silicon oxide, a silicon alloy, and combinations thereof.

8. The composite negative electrode active material of claim 2, wherein the silicon-based active material is a composite comprising a carbon-based material.

9. A negative electrode active material layer for an all-solid-state battery, the negative electrode active material layer comprising:
a composite negative electrode active material comprising:
a negative electrode active material comprising a silicon-based active material; and
a coating layer comprising a solid electrolyte and coating a portion of a surface of the negative electrode active material, wherein a ratio (E/T) of a Young's modulus (E) of the solid electrolyte to a thickness (T) of the coating layer satisfies 0.02<E/T<0.06, and wherein a ratio (T/d) of the thickness (T) of the coating layer to a particle diameter (d; nm) of the negative electrode active material satisfies 20<T/d<100; and
an electrode solid electrolyte.

10. The negative electrode active material layer of claim 9, wherein the thickness of the coating layer is in a range of 200 nm to 750 nm.

11. The negative electrode active material layer of claim 9, wherein the Young's modulus of the solid electrolyte is in a range of 8 GPa to 22 GPa.

12. The negative electrode active material layer of claim 9, wherein the solid electrolyte coats an entirety of the surface of the negative electrode active material.

13. The negative electrode active material layer of claim 9, wherein the solid electrolyte comprises a sulfide-based solid electrolyte.

14. The negative electrode active material layer of claim 9, wherein the silicon-based active material comprises a material selected from the group consisting of a silicon particle, silicon oxide, a silicon alloy, and combinations thereof.

15. The negative electrode active material layer of claim 9, wherein the silicon-based active material is a composite comprising a carbon-based material.

16. A method of forming a composite negative electrode active material layer for an all-solid-state battery, the method comprising:
synthesizing a composite negative electrode active material by introducing a negative electrode active material and a solid electrolyte into a mixer at a weight ratio in a range of 9:1 to 7:3 and then mixing the negative electrode active material and the solid electrolyte;
preparing a negative electrode active material slurry by mixing the composite negative electrode active material and an electrode solid electrolyte; and
forming a negative electrode active material layer by applying and drying the negative electrode active material slurry on a negative electrode current collector.

17. The method of claim 16, wherein the composite negative electrode active material comprises:
the negative electrode active material comprising a silicon-based active material; and
a coating layer comprising the solid electrolyte and coating a portion of a surface of the negative electrode active material, wherein a ratio (E/T) of a Young's modulus (E) of the solid electrolyte to a thickness (T) of the coating layer satisfies 0.02<E/T<0.06.

18. The method of claim 17, wherein a ratio (T/d) of the thickness (T) of the coating layer to a particle diameter (d) of the negative electrode active material satisfies 20<T/d<100.

19. The method of claim 16, wherein the mixer comprises a resonant acoustic mixer (RAM).

20. The method of claim 16, wherein:
the mixer comprises a plurality of metal balls having a diameter of 10 mm or less; and
a weight ratio of a sum of the negative electrode active material and the solid electrolyte in powder form to the metal balls is in a range of 1:7 to 1:9.
